(19) United States
(12) Patent Application Publication
(10) Pub. No.: US 2020/0234184 A1
(43) Pub. Date: Jul. 23, 2020

(54) ADVERSARIAL TREATMENT TO MACHINE LEARNING MODEL ADVERSARY

(71) Applicant: International Business Machines Corporation, Armonk, NY (US)

(72) Inventors: Manish Kesarwani, Bangalore (IN); Deepak Vijaykeerthy, Chennai (IN); Sameep Mehta, New Delhi (IN); Suranjana Samanta, Bangalore (IN); Karthik Sankaranarayanan, Bangalore (IN)

(21) Appl. No.: 16/255,620

(22) Filed: Jan. 23, 2019

(51) Int. Cl. G06N 20/00; G06F 16/903

(52) U.S. Cl. CPC G06N 20/00; G06F 16/90335

(57) ABSTRACT

One embodiment provides a method, including: deploying a machine learning model, wherein the machine learning model is used in responding to queries from users; receiving, at the deployed machine learning model, input from at least one entity; determining that the at least one entity is an adversary attempting to retrain and/or steal the deployed machine learning model; and providing, in view of the determining that the at least one entity is an adversary, an altered response, wherein the altered response comprises at least one of: a response from a machine learning model other than the deployed machine learning model and a response from the deployed machine learning model altered with errors.

### BACKGROUND

Machine learning is the ability of a computer to learn without being explicitly programmed to perform some function. Thus, machine learning allows a programmer to initially program an algorithm that can be used to predict responses to data, without having to explicitly program every response to every possible scenario that the computer may encounter. In other words, machine learning uses algorithms that the computer uses to learn from and make predictions with regard to data. Machine learning provides a mechanism that allows a programmer to program a computer for computing tasks where design and implementation of a specific algorithm that performs well is difficult or impossible. To implement machine learning, the computer is initially taught using machine learning models from sample inputs. The computer can then learn from the machine learning model in order to make decisions when actual data are introduced to the computer.

Some applications utilize machine learning models that are continuously updated based upon received inputs or feedback. For example, a recommendation application may recommend certain products based upon feedback provided by other users. As an example, if users provide feedback indicating that a particular product performs well or performs poorly, the machine learning model can use this input or feedback to assist in making future recommendations. These machine learning models are continuously updated and retrained as new user inputs and feedback are received. This continuous updating allows for the machine learning model to adapt and provide responses that are based upon more current information.

### BRIEF SUMMARY

In summary, one aspect of the invention provides a method comprising: deploying a machine learning model, wherein the machine learning model is used in responding to queries from users; receiving, at the deployed machine learning model, input from at least one entity; determining that the at least one entity is an adversary attempting to retrain and/or steal the deployed machine learning model; and providing, in view of the determining that the at least one entity is an adversary, an altered response, wherein the altered response comprises at least one of: a response from a machine learning model other than the deployed machine learning model and a response from the deployed machine learning model altered with errors.

Another aspect of the invention provides an apparatus, comprising: at least one processor; and a computer readable storage medium having computer readable program code embodied therewith and executable by the at least one processor, the computer readable program code comprising: computer readable program code configured to deploy a machine learning model, wherein the machine learning model is used in responding to queries from users; computer readable program code configured to receive, at the deployed machine learning model, input from at least one entity; computer readable program code configured to determine that the at least one entity is an adversary attempting to retrain and/or steal the deployed machine learning model; and computer readable program code configured to provide, in view of the determining that the at least one entity is an adversary, an altered response, wherein the altered response comprises at least one of: a response from a machine learning model other than the deployed machine learning model and a response from the deployed machine learning model altered with errors.

An additional aspect of the invention provides a computer program product, comprising: a computer readable storage medium having computer readable program code embodied therewith, the computer readable program code executable by a processor and comprising: computer readable program code configured to deploy a machine learning model, wherein the machine learning model is used in responding to queries from users; computer readable program code configured to receive, at the deployed machine learning model, input from at least one entity; computer readable program code configured to determine that the at least one entity is an adversary attempting to retrain and/or steal the deployed machine learning model; and computer readable program code configured to provide, in view of the determining that the at least one entity is an adversary, an altered response, wherein the altered response comprises at least one of: a response from a machine learning model other than the deployed machine learning model and a response from the deployed machine learning model altered with errors.

A further aspect of the invention provides a method, comprising: employing a machine learning model to respond to queries from one or more entities; determining from a pattern of queries that the one or more entities comprises an adversary attempting to steal the machine learning model; selecting, from the machine learning model and a variation of the machine learning model, a model to be used to provide responses to the queries, wherein the selecting comprises selecting a variation of the machine learning model if the one or more entities are determined to be an adversary; and providing responses to the queries using the selected model.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 illustrates a method of determining a machine learning model adversary and providing adversarial treatment to the identified adversary.

FIG. 2 illustrates an example system for providing adversarial treatment to a machine learning model adversary.

FIG. 3 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art may well recognize, however, that embodiments of the invention can be practiced without at least one of the specific details thereof, or can be practiced with other methods, components, materials, et cetera. In other instances, well-known structures, materials, or operations are not shown or described in detail to avoid obscuring aspects of the invention.

The illustrated embodiments of the invention will be best understood by reference to the figures. The following description is intended only by way of example and simply illustrates certain selected exemplary embodiments of the invention as claimed herein. It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

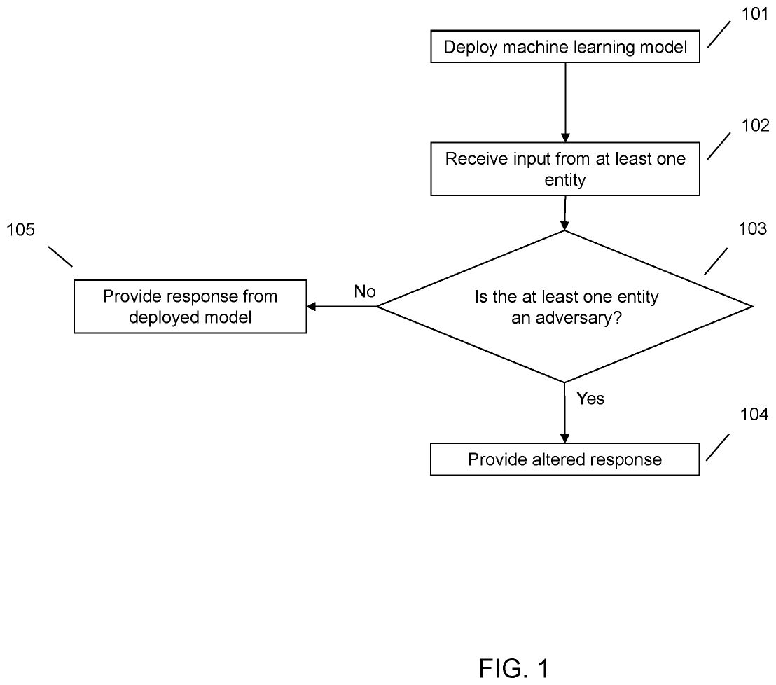

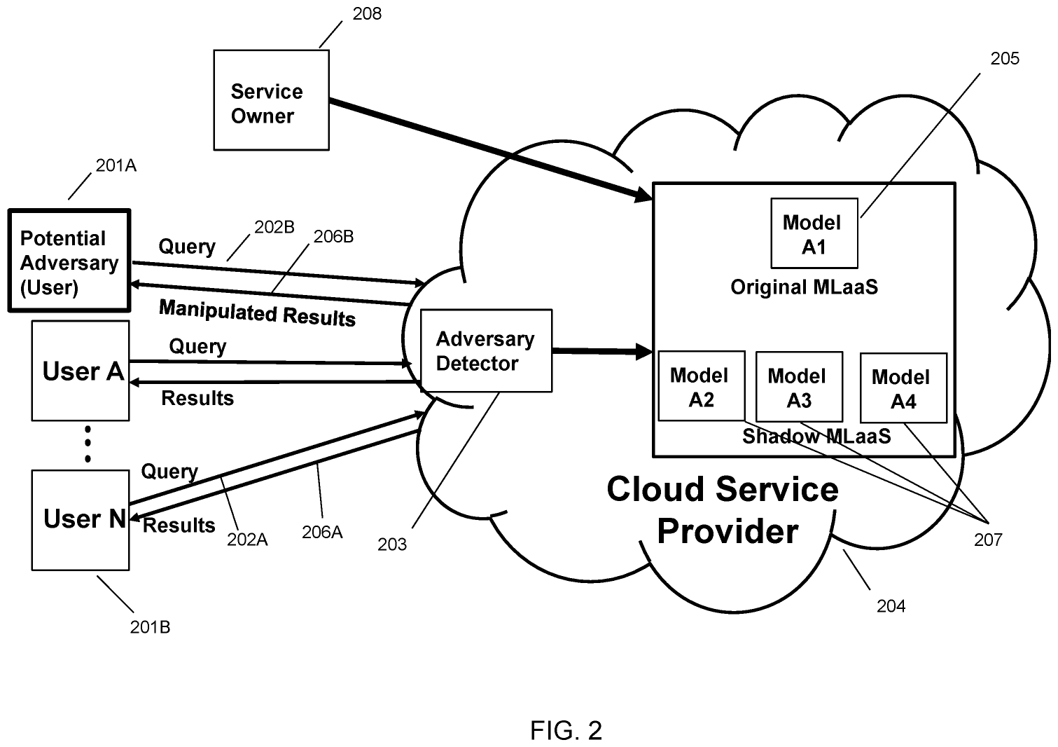

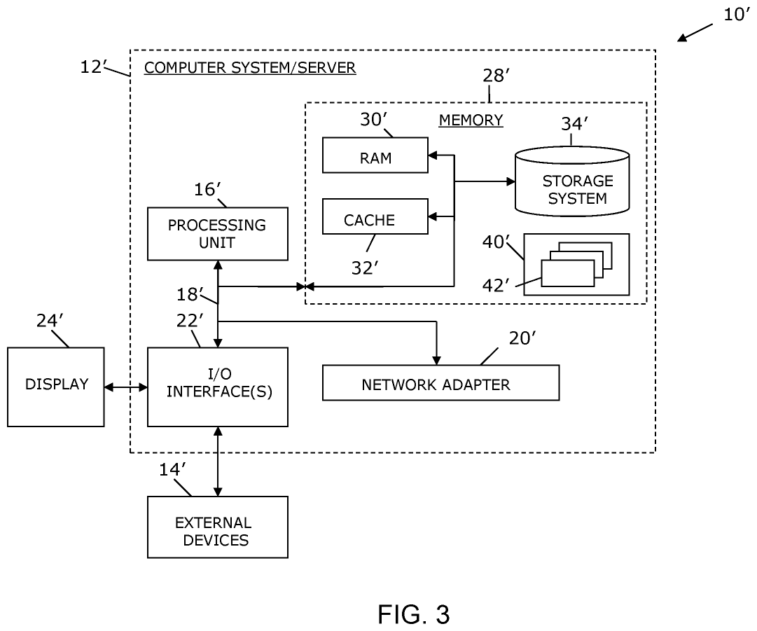

Specific reference will be made here below to FIGS. 1-3. It should be appreciated that the processes, arrangements and products broadly illustrated therein can be carried out on, or in accordance with, essentially any suitable computer system or set of computer systems, which may, by way of an illustrative and non-restrictive example, include a system or server such as that indicated at 12′ in FIG. 3. In accordance with an example embodiment, all of the process steps, components and outputs discussed with respect to FIGS. 1-2 can be performed or utilized by way of a processing unit or units and system memory such as those indicated, respectively, at 16′ and 28′ in FIG. 3, whether on a server computer, a client computer, a node computer in a distributed network, or any combination thereof.

Many machine learning models are deployed as machine learning as a service models. Machine learning as a service models mean that the machine learning model is deployed and accessible to at least one entity other than the machine learning model owner. The other entity can use or access the machine learning model to perform some task or service for the entity. For example, the entity may need a recommendation machine learning model. Rather than generating the recommendation machine learning model, the entity may simply use a machine learning model that has been deployed as a service. The entity usually pays per usage of the machine learning model. The machine learning model owner also gains a larger visibility for the machine learning model, meaning that if the machine learning model owner is attempting to train the model using feedback from users, the machine learning model is exposed to more users and feedback. From the perspective of the entity using the machine learning model, the entity does not have to purchase and manage expensive hardware or software and does not need to create the machine learning model. However, the machine learning model as a service suffers from the problem that, since the model is exposed to the public, users may attempt to attack the model.

One type of attack that a user may employ is a retraining attack. In such an attack one or more users attempt to retrain or shift the model into providing inaccurate or incorrect responses. Crowdsourcing, or receiving input from a plurality of users regarding a product, application, or service, to train a machine learning model is an effective technique for training a model where the data distribution is not known at the time the model is created. This technique also provides a method that allows the model to adapt to the desired environment or context that the model is being used in. For example, if the model is deployed in a recommendation engine, the model can be adapted to provide recommendations on many different products or services that may be introduced after the model is deployed. However, since the machine learning models can be trained using input received from users, users can provide input that retrains the model to provide responses that are incorrect or inaccurate. Thus, machine learning models, particularly those that are retrained using feedback or input received from users, can be susceptible to retraining attacks where one or more users purposely manipulates the training data so that the machine learning model does not respond correctly.

Another attack that machine learning models may also be susceptible to is a stealing attack. A stealing attack is an attack where one or more users attempt to learn enough about the machine learning model to allow the one or more users to duplicate the machine learning model or the training data associated with the machine learning model. Stealing attacks are applicable to any public machine learning model, for example, the machine learning as a service model. A public machine learning model is a machine learning model that is accessible (e.g., a user can provide input either directly or indirectly) to a user other than the machine learning model developer or the machine learning model owner. Many machine learning models are public machine learning models which are susceptible to stealing attacks. For example, the machine learning models may be employed in conjunction with an application, where the machine learning model is used to provide information to a user (e.g., a response to a query, predict results, etc.).

Conventional techniques have focused on determining how attacks occur and, therefore, identification of the attacks. Based upon the identification of the types of attacks and how the attacks are carried out, developers of machine learning models have attempted to develop machine learning models that are not as susceptible to the attacks (e.g., by making the machine learning model, the algorithms used to create the machine learning model, and the training data used for training the machine learning model more complex). However, such an approach is not feasible for all types of machine learning models. For example, certain types of machine learning models that may not be as resistant to certain attacks may be the type of machine learning model that needs to be deployed for a particular application. Additionally, a complex machine learning model may be resistant to certain attacks, but may be susceptible to other attacks. In other words, strengthening one feature of a machine learning model may make the machine learning model vulnerable to other types of attacks.

Accordingly, the techniques and systems as described herein provide a system and technique for determining a machine learning model adversary and providing adversarial treatment to the identified adversary. A machine learning model may be deployed, for example, as a machine learning as a service model, to assist in responding to queries provided by users. For example, the machine learning model may be a recommendation model, an image classifier model, a customer service model, or the like. The machine learning model system may then receive input from at least one entity, for example, a query or input from an entity that wants to use the machine learning model. From the received query or input the system can identify whether the at least one entity is an adversary that is attempting to retrain or steal the deployed machine learning model. The identification of the adversary may be accomplished by monitoring query patterns of the one or more entities. These query patterns may indicate that the adversary is attempting to attack (e.g., steal, retrain, etc.) the deployed machine learning model.

If the system determines that the at least one entity is an adversary, the system may provide an altered response to the query from the identified adversary. The altered response may be a response that is provided from a shadow machine learning model. This shadow machine learning model is a model that is different than the deployed machine learning model in performance characteristics. In other words, the shadow machine learning model is a model that provides responses different from those of the deployed machine learning model. Additionally or alternatively, the altered response may be a response from the deployed machine learning model that has been altered to introduce errors into the response.

Such a system provides a technical improvement over current systems for development of machine learning models. Rather than requiring the machine learning model developer to change the machine learning model to make the model more resilient to attacks, the described system and methods can detect an adversary and then change the response provided by the model, thereby providing the adversary with responses that are different than the deployed machine learning model. In other words, the described system and method can effectively poison the adversary, thereby preventing stealing of the deployed machine learning model. Thus, the described system and method provide a more efficient and effective method of managing machine learning model adversaries than conventional systems which require the machine learning model developer to change the machine learning model, which may be unfeasible in many machine learning models.

FIG. 1 illustrates a method for determining a machine learning model adversary and providing adversarial treatment to the identified adversary. At 101 the system may deploy a model for responding to requests, inputs, or feedback received from users, for example, a machine learning as a service model. The model may be deployed in conjunction with an application. For example, an application may include a recommendation engine which uses a machine learning model to provide recommendations. As another example, an application may be an image analysis application that includes an image classification engine that uses a machine learning model to classify or label different images or portions of images. In other words, the application may employ a machine learning model to perform a function of the application. The model may be deployed as a public model, meaning that entities other than the model owner can access the model. Thus, the machine learning model may include a public interface. Additionally, the model may include a machine learning model that is trained using input captured from a plurality of users, or, in other words, trained using crowdsourcing techniques.

At 102 the system may receive input from at least one entity (e.g., user, group of users, company, etc.) at the deployed machine learning model. For example, a user may provide a query to an application that employs the machine learning model or to a public interface of the machine learning model. As another example, the user may provide feedback in response to an output of the machine learning model or feedback in response to something within the application utilizing the machine learning model. The feedback may also include input that is not directed to the machine learning model but is rather used by the machine learning model for training. In other words, the feedback may include any type of training data that can be used by the machine learning model to learn. Thus, the received input may be input provided directly to the machine learning model or may include input that is indirectly captured by the machine learning model.

At 103 the system may determine whether the at least one entity is an adversary. A machine learning model adversary is an entity that is attempting to retrain or steal the machine learning model. In other words, an adversary is an entity that is attempting to attack the machine learning model. It should be understood that while an adversary may be a single user or entity, an adversary may also be a group of users or entities that are colluding to attempt to attack the machine learning model. To identify whether the entity is an adversary the system may use one or a combination of adversary identification techniques. As an example, to identify the adversary, the system may use a model extraction warning. This technique monitors the input patterns of entities and if these input patterns are similar to input patterns that are indicative of a machine learning model attack, the system may produce a warning or alert to a user or the system. This warning or alert can then trigger the system to identify this entity as an adversary.

As another example, to identify an adversary the system may compare a profile of an entity to a list of profiles that are known adversaries. The profile of the entity may also provide information that may be indicative that the entity is an adversary. For example, if the profile of the entity indicates that the entity has provided a large number of inputs or queries that would assist in attacking the machine learning model within a period of time, specifically, before the model is upgraded, the system may identify this profile as being associated with an adversary.

As another example, to identify the adversary the system may use a resiliency score that corresponds to the deployed machine learning model. The resiliency score of the deployed machine learning model identifies how resilient the machine learning model is against one or more types of attacks, for example, a stealing attack, a retraining attack, or the like. The deployed machine learning model may be more resilient to one attack than to another attack. Thus, the system may compute a resiliency score that identifies a steal threshold or value that corresponds to a pattern of inputs that would be indicative of an adversary attempting to attack the machine learning model. Accordingly, to identify an adversary, the system may observe a pattern of inputs provided by the entity and identify if the pattern of inputs reaches the attack threshold or resiliency score.

As an example, to steal the machine learning model, an adversary would have to provide multiple inputs or queries to identify the boundary of the machine learning model, which would allow the adversary to recreate the machine learning model. Thus, the adversary would provide a number of queries within a short period of time to learn these boundaries, particularly a number of queries that are near the boundaries. Accordingly, if the system detects that an entity is providing a number of inputs that are near the machine learning model boundaries within a predetermined length of time, the system may detect that this input pattern is indicative of a stealing attack and may identify the entity as an adversary.

If the system identifies that the entity is not an adversary at 103, the system may provide input from the deployed machine learning model at 105. In other words, the system may provide an accurate or correct response from the deployed machine learning model. If, however, the system identifies the entity as an adversary at 103, the system may provide an altered response at 104. The altered response may be a response that is provided from a shadow machine learning model. A shadow machine learning model is a machine learning model that is similar to the deployed machine learning model, but that has different performance characteristics than the deployed machine learning model and that provides different responses than what would be provided from the deployed machine learning model.

In the case that a shadow machine learning model is unavailable, the system can simulate a shadow machine learning model by altering the responses provided by the deployed machine learning model. For example, the system may introduce errors into the responses provided by the deployed machine learning model before providing these responses to the adversary. Thus, the altered response may include a response from the deployed machine learning model that has been altered with errors. The system then provides the altered responses, either from the shadow model or the responses with errors, to the adversary. For ease of reading, the term shadow model refers to either a unique machine learning model that is different from the deployed shadow model or a simulated shadow model that is created by altering responses from the deployed machine learning model with errors. Accordingly, the adversary learns incorrect information and learns the shadow model rather than the deployed machine learning model, thereby effectively poisoning the adversary.

The system may use a single shadow model or simulated shadow model for a single or unique adversary. In other words, the system may provide responses from one shadow model to one adversary. A different adversary will receive responses from a different shadow model. Thus, each shadow model or simulated shadow model may be unique to each adversary. Using unique shadow models may allow for determining a stolen model at a later time. In other words, each of the unique shadow models may be used as evidence to provide that an entity stole a machine learning model, specifically the shadow model. Accordingly, if a user suspects that an entity has deployed a machine learning model that resembles a shadow model developed by the user, the user can compare the entity deployed machine learning model to the shadow model. Since the shadow model was used only on a single entity, the user can provide evidence that the entity deployed machine learning model was stolen from the user and can guarantee that the entity could not have gotten the entity deployed machine learning model from a different place.

FIG. 2 illustrates an overall example of the described system. One or more users, which may include a potential adversary 201A and 201B, may provide queries 202A and 202B to a machine learning model system deployed by a service owner 208. In this example, the machine learning model system is deployed by the service owner 208 at a cloud service provider 204. These queries may be intercepted by an adversary detector 203 that can identify an adversary 201A from the users 201B based upon the provided queries 202B and 202A. In the case of the legitimate users 201B, the adversary indicates that they are legitimate and, therefore, passes these queries 202A to the original or legitimate machine learning model 205. The users 201B are then provided legitimate or accurate responses or results 206A. In the case of the adversary 201A the adversary detector passes the adversary queries 202B to one of the shadow models 207. The adversary 201A is then provided responses 206B from the shadow model instead of the legitimate machine learning model 205.

Thus, the described system and method provide an improvement over a conventional system for protecting a machine learning model. Instead of requiring a machine learning model developer to attempt to develop a machine learning model that is resilient to all types of attacks, the system can identify adversaries attempting to attack the machine learning model and poison the adversary. Thus, the described system is more effective and provides a more efficient technique for addressing machine learning model attacks from adversaries.

As shown in FIG. 3, computer system/server 12′ in computing node 10′ is shown in the form of a general-purpose computing device. The components of computer system/server 12′ may include, but are not limited to, at least one processor or processing unit 16′, a system memory 28′, and a bus 18′ that couples various system components including system memory 28′ to processor 16′. Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that are accessible by computer system/server 12′, and include both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ (by way of example, and not limitation), as well as an operating system, at least one application program, other program modules, and program data. Each of the operating systems, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enables a user to interact with computer system/server 12′; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples include, but are not limited to: microcode, device drivers, redundant processing units, external disk drive arrays, RAID systems, tape drives, and data archival storage systems, etc.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions. These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A method, comprising:
deploying a machine learning model, wherein the machine learning model is used in responding to queries from users;
receiving, at the deployed machine learning model, input from at least one entity;
determining that the at least one entity is an adversary attempting to retrain and/or steal the deployed machine learning model; and
providing, in view of the determining that the at least one entity is an adversary, an altered response, wherein the altered response comprises at least one of: a response from a machine learning model other than the deployed machine learning model and a response from the deployed machine learning model altered with errors.

2. The method of claim 1, wherein the determining comprises determining that the at least one entity has provided a predetermined number of inputs to the deployed machine learning model within a predetermined time frame.

3. The method of claim 1, wherein the determining comprises comparing a profile of the at least one entity to profiles of known adversaries.

4. The method of claim 1, wherein the determining comprises computing a resiliency score for the deployed machine learning model that identifies an attack threshold corresponding to an input pattern that is indicative of the deployed machine learning model being attacked.

5. The method of claim 4, wherein the determining comprises (i) observing a pattern of input provided by the at least one entity and (ii) determining the at least one entity as an adversary when the pattern of input reaches the attack threshold.

6. The method of claim 1, wherein the machine learning model other than the deployed machine learning model is used for providing responses for a single adversary.

7. The method of claim 6, comprising determining that the single adversary attempted to steal the deployed machine learning model, by comparing a model deployed by the single adversary to the machine learning model other than the deployed machine learning model.

8. The method of claim 1, wherein the machine learning model other than the deployed machine learning model has different performance characteristics than the deployed machine learning model.

9. The method of claim 1, wherein the machine learning model comprises a public model.

10. The method of claim 1, wherein the deployed machine learning model altered with errors comprises errors that are unique to each entity identified as an adversary.

11. An apparatus, comprising:
at least one processor; and
a computer readable storage medium having computer readable program code embodied therewith and executable by the at least one processor, the computer readable program code comprising:
computer readable program code configured to deploy a machine learning model, wherein the machine learning model is used in responding to queries from users;
computer readable program code configured to receive, at the deployed machine learning model, input from at least one entity;
computer readable program code configured to determine that the at least one entity is an adversary attempting to retrain and/or steal the deployed machine learning model; and
computer readable program code configured to provide, in view of the determining that the at least one entity is an adversary, an altered response, wherein the altered response comprises at least one of: a response from a machine learning model other than the deployed machine learning model and a response from the deployed machine learning model altered with errors.

12. A computer program product, comprising:
a computer readable storage medium having computer readable program code embodied therewith, the computer readable program code executable by a processor and comprising:
computer readable program code configured to deploy a machine learning model, wherein the machine learning model is used in responding to queries from users;
computer readable program code configured to receive, at the deployed machine learning model, input from at least one entity;
computer readable program code configured to determine that the at least one entity is an adversary attempting to retrain and/or steal the deployed machine learning model; and
computer readable program code configured to provide, in view of the determining that the at least one entity is an adversary, an altered response, wherein the altered response comprises at least one of: a response from a machine learning model other than the deployed machine learning model and a response from the deployed machine learning model altered with errors.

13. The computer program product of claim 12, wherein the determining comprises determining that the at least one entity has provided a predetermined number of inputs to the deployed machine learning model within a predetermined time frame.

14. The computer program product of claim 12, wherein the determining comprises comparing a profile of the at least one entity to profiles of known adversaries.

15. The computer program product of claim 12, wherein the determining comprises computing a resiliency score for the deployed machine learning model that identifies an attack threshold corresponding to an input pattern that is indicative of the deployed machine learning model being attacked.

16. The computer program product of claim 15, wherein the determining comprises (i) observing a pattern of input provided by the at least one entity and (ii) determining the at least one entity as an adversary when the pattern of input reaches the attack threshold.

17. The computer program product of claim 12, wherein the machine learning model other than the deployed machine learning model is used for providing responses for a single adversary.

18. The computer program product of claim 17, comprising determining that the single adversary attempted to steal the deployed machine learning model, by comparing a model deployed by the single adversary to the machine learning model other than the deployed machine learning model.

19. The computer program product of claim 12, wherein the deployed machine learning model altered with errors comprises errors that are unique to each entity identified as an adversary.

20. A method, comprising:
employing a machine learning model to respond to queries from one or more entities;
determining from a pattern of queries that the one or more entities comprises an adversary attempting to steal the machine learning model;
selecting, from the machine learning model and a variation of the machine learning model, a model to be used to provide responses to the queries, wherein the selecting comprises selecting a variation of the machine learning model if the one or more entities are determined to be an adversary; and
providing responses to the queries using the selected model.
